(19) United States
(12) Patent Application Publication
(10) Pub. No.: US 2014/0163168 A1
(43) Pub. Date: Jun. 12, 2014

(54) POLYMER-CLAY NANOCOMPOSITE MATERIAL

(71) Applicant: KING FAHD UNIVERSITY OF PETROLEUM AND MINERALS, Dhahran (SA)

(72) Inventors: MOHAMMAD NAHID SIDDIQUI, DHAHRAN (SA); HALIM HAMID REDHWI, DHAHRAN (SA); DIMITRIS S. ACHILIAS, THESSALONIKI (GR); KLONTIAN GKINIS, THESSALONIKI (GR)

(73) Assignee: KING FAHD UNIVERSITY OF PETROLEUM AND MINERALS, DHAHRAN (SA)

(21) Appl. No.: 13/712,800

(22) Filed: Dec. 12, 2012

(51) Int. Cl. C08K 13/02

(52) U.S. Cl. CPC C08K 13/02
USPC 524/777

(57) ABSTRACT

The polymer-clay nanocomposite material is a nanocompo site formed from poly(styrene-co-butyl methacrylate) copolymer and organo-modified clay by in situ polymerization. Nanoparticles of a montmorillonite clay that has been modified with a quaternary ammonium salt is dispersed into a mixture of polystyrene and butyl methacrylate monomers to form a mixture, which then undergoes bulk radical polymerization. The poly(styrene-co-butyl methacrylate) copolymer may have a styrene to butyl methacrylate ratio of about 60 to 40 or about 20:80. Preferably, the organically modified montmorillonite clay forms between 1.0 wt % and 5.0 wt % of the mixture. A free radical initiator, such as benzoyl peroxide, is used to initiate polymerization. The clay nano-filler provides the nanocomposite with improved thermal stability.

### BACKGROUND OF THE INVENTION

1. Field of the Invention

The present invention relates to nanocomposite materials, and particularly to a polymer-clay nanocomposite material that provides a nanocomposite made from poly(styrene-co-butyl methacrylate) and organo-modified clay by in situ polymerization.

2. Description of the Related Art

Compared to conventional filled polymers, polymer/layered silicate nanocomposites have recently attracted the attention of researchers due to their unique material properties. Specifically, the addition of only a very small amount of clay (typically less than 5 wt %) to a polymeric matrix has a significant impact on the mechanical, thermal, fire and barrier properties of the polymer.

The formation of polymer-based nanocomposites has been achieved by several methods, including in situ polymerization, polymer melting, and solution intercalation/exfoliation. Among these, dispersing in situ polymerization may be the most desirable method for preparing nanocomposites, since the types of nanoparticles and the nature of polymer precursors can vary in a wide range to meet the requirements of the process. In in situ polymerization, the clay is swollen in the monomer for a certain time, depending on the polarity of the monomer molecules and the surface treatment of clay. The monomer migrates into the galleries of the layered silicate so that the polymerization reaction occurs between the intercalated sheets. Long-chain polymers within the clay galleries are thus produced.

Although such in situ techniques have been studied with respect to bulk free radical polymerization, such techniques have not been widely applied to methacrylates. Given the broad and far-ranging applications of methacrylates, it would obviously be desirable to be able to modify and improve their properties through such a process.

Thus, a polymer-clay nanocomposite material solving the aforementioned problems is desired.

### SUMMARY OF THE INVENTION

The polymer-clay nanocomposite material is a nanocomposite formed from poly(styrene-co-butyl methacrylate) copolymer and organo-modified clay by in situ polymerization. Nanoparticles of a montmorillonite clay that has been modified with a quaternary ammonium salt is dispersed into a mixture of styrene and butyl methacrylate monomers to form a mixture, which then undergoes bulk radical polymerization. The poly(styrene-co-butyl methacrylate) copolymer may have a styrene to butyl methacrylate ratio of about 60 to 40 or about 20:80. Preferably, the organically modified montmorillonite clay forms between 1.0 wt % and 5.0 wt % of the mixture. A free radical initiator, such as benzoyl peroxide, is used to initiate polymerization. The clay nano-filler provides the nanocomposite with improved thermal stability.

These and other features of the present invention will become readily apparent upon further review of the following specification and drawings.

### BRIEF DESCRIPTION OF THE DRAWINGS

FIG. 1 is a chart showing the ¹H nuclear magnetic resonance (NMR) spectrum of a poly(styrene-co-butyl methacrylate) copolymer having a styrene to butyl methacrylate ratio of about 60 to 40.

FIG. 2A is a chart showing the Fourier-transform infrared (FTIR) spectra of a polymer-clay nanocomposite material according to the present invention, with concentrations of a CLOISITE® 15A organo-modified clay being shown for 1.0 wt %, 3.0 wt % and 5.0 wt %.

FIG. 2B is a chart showing the Fourier-transform infrared (FTIR) spectra of a polymer-clay nanocomposite material according to the present invention, with concentrations of a CLOISITE® 10A organo-modified clay being shown for 1.0 wt %, 3.0 wt % and 5.0 wt %.

FIG. 3A is a chart showing the X-ray diffraction (XRD) spectra of a polymer-clay nanocomposite material according to the present invention, with concentrations of a CLOISITE® 10A organo-modified clay being shown for 1.0 wt %, 3.0 wt % and 5.0 wt %, and with a styrene to butyl methacrylate ratio of about 20 to 80.

FIG. 3B is a chart showing the X-ray diffraction (XRD) spectra of a polymer-clay nanocomposite material according to the present invention, with concentrations of a CLOISITE® 15A organo-modified clay being shown for 1.0 wt %, 3.0 wt % and 5.0 wt %, and with a styrene to butyl methacrylate ratio of about 20 to 80.

FIG. 4 is a graph illustrating percent conversion vs. time curves for polystyrene, pure poly(butyl methacrylate), and poly(styrene-co-butyl methacrylate) copolymers having styrene to butyl methacrylate ratios of about 20 to 80 and about 60:40.

FIG. 5A is a graph illustrating percent conversion vs. time curves for a polymer-clay nanocomposite material according to the present invention, with concentrations of a CLOISITE® 10A organo-modified clay being shown for 1.0 wt %, 3.0 wt % and 5.0 wt %, and with a styrene to butyl methacrylate ratio of about 20 to 80.

FIG. 5B is a graph illustrating percent conversion vs. time curves for a polymer-clay nanocomposite material according to the present invention, with concentrations of a CLOISITE® 15A organo-modified clay being shown for 1.0 wt %, 3.0 wt % and 5.0 wt %, and with a styrene to butyl methacrylate ratio of about 20 to 80.

FIG. 6A is a graph illustrating percent conversion vs. time curves for a polymer-clay nanocomposite material according to the present invention, with concentrations of a CLOISITE® 10A organo-modified clay being shown for 1.0 wt %, 3.0 wt % and 5.0 wt %, and with a styrene to butyl methacrylate ratio of about 60 to 40.

FIG. 6B is a graph illustrating percent conversion vs. time curves for a polymer-clay nanocomposite material according to the present invention, with concentrations of a CLOISITE® 15A organo-modified clay being shown for 1.0 wt %, 3.0 wt % and 5.0 wt %, and with a styrene to butyl methacrylate ratio of about 60 to 40.

FIG. 7A is a graph illustrating molecular weight distribution curves for a polymer-clay nanocomposite material according to the present invention, with concentrations of a CLOISITE® 15A organo-modified clay being shown for 1.0 wt %, 3.0 wt % and 5.0 wt %, and with a styrene to butyl methacrylate ratio of about 20 to 80.

FIG. 7B is a graph illustrating molecular weight distribution curves for a polymer-clay nanocomposite material according to the present invention, with concentrations of a CLOISITE® 10A organo-modified clay being shown for 1.0 wt %, 3.0 wt % and 5.0 wt %, and with a styrene to butyl methacrylate ratio of about 20 to 80.

FIG. 8A is a graph illustrating molecular weight distribution curves for a polymer-clay nanocomposite material according to the present invention, with concentrations of a CLOISITE® 15A organo-modified clay being shown for 1.0 wt %, 3.0 wt % and 5.0 wt %, and with a styrene to butyl methacrylate ratio of about 60 to 40.

FIG. 8B is a graph illustrating molecular weight distribution curves for a polymer-clay nanocomposite material according to the present invention, with concentrations of a CLOISITE® 10A organo-modified clay being shown for 1.0 wt %, 3.0 wt % and 5.0 wt %, and with a styrene to butyl methacrylate ratio of about 60 to 40.

FIG. 9 is a graph illustrating percent mass loss as a function of temperature for samples of CLOISITE® 10A organo-modified clay, CLOISITE® 15A organo-modified clay, and CLOISITE® Na⁺ organo-modified clay.

FIG. 10A is a graph illustrating percent mass loss as a function of time for a polymer-clay nanocomposite material according to the present invention, using CLOISITE® 15A organo-modified clay, and with a styrene to butyl methacrylate ratio of about 20 to 80.

FIG. 10B is a graph illustrating differential thermogravimetric analysis for a polymer-clay nanocomposite material according to the present invention, using CLOISITE® 15A organo-modified clay, and with a styrene to butyl methacrylate ratio of about 20 to 80.

FIG. 11A is a graph illustrating percent mass loss as a function of time for a polymer-clay nanocomposite material according to the present invention, using CLOISITE® 10A organo-modified clay, and with a styrene to butyl methacrylate ratio of about 20 to 80.

FIG. 11B is a graph illustrating differential thermogravimetric analysis for a polymer-clay nanocomposite material according to the present invention, using CLOISITE® 10A organo-modified clay, and with a styrene to butyl methacrylate ratio of about 20 to 80.

FIG. 12A is a graph illustrating percent mass loss as a function of time for a polymer-clay nanocomposite material according to the present invention, using CLOISITE® 10A organo-modified clay, and with a styrene to butyl methacrylate ratio of about 60 to 40.

FIG. 12B is a graph illustrating differential thermogravimetric analysis for a polymer-clay nanocomposite material according to the present invention, using CLOISITE® 10A organo-modified clay, and with a styrene to butyl methacrylate ratio of about 60 to 40.

Similar reference characters denote corresponding features consistently throughout the attached drawings.

### DETAILED DESCRIPTION OF THE PREFERRED EMBODIMENTS

Two copolymers with differing styrene to butyl methacrylate (BMA) ratios were examined in the preparation of initial monomer-nanoclay mixtures used in the preparation of a polymer-clay nanocomposite material. The first copolymer had a styrene to BMA ratio of 20:80 and the second copolymer had a styrene to BMA ratio of 60:40. The latter copolymer corresponds to the azeotropic composition of the mixture; i.e., the copolymer has the same composition as the initial monomer mixture. The poly(styrene-co-butyl methacrylate) copolymer has the structural form:

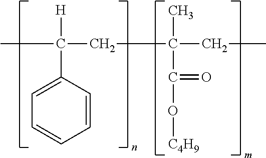

Initially, a monomer mixture of styrene with BMA was prepared. Organo-montmorillonite (OMMT) was then added to 25 g of the monomer mixture. The OMMT was dispersed in the monomer mixture within a 100 mL conical flask by magnetic and ultrasonic agitation. The magnetic agitation was performed for 24 hours, and the supersonic agitation was performed for one hour for each prepared sample. The dispersion of the particles in the monomer mixture was homogeneous, as indicated by a high translucency in the visible region. In the final suspension, 0.03 M benzoyl peroxide (BPO) was added as a free radical initiator, and the mixture was degassed by nitrogen passing.

Two series of the polymer-clay nanocomposites were prepared by in situ free radical bulk polymerization. In the first series, CLOISITE® 15A, an organically-modified montmorillonite clay manufactured by Southern Clay Products, Inc. of Gonzales, Tex. was used in differing relative amounts of 1.0, 3.0 and 5.0 wt %, compared to the monomer mixture. In the second series, the type of the nano-clay used was CLOISITE® 10A, again at relative amounts of 1.0, 3.0 and 5.0 wt % compared to the monomer mixture. The organic modifier in CLOISITE® 15A is a quaternary ammonium salt, viz., a dimethyl, dihydrogenated tallow quaternary ammonium salt, and the organic modifier in CLOISITE® 10A is also a quaternary ammonium salt, viz., a dimethyl, benzyl, hydrogenated tallow quaternary ammonium salt. Copolymers as described above, having styrene to BMA ratios of 20:80 and 60:40, were also prepared to be used as reference materials for control comparisons.

In order to study the reaction kinetics, free radical bulk polymerization was carried out in small test-tubes by heating the initial monomer-nanoclay-initiator mixture at 80° C. About 2 mL of the pre-weighted mixtures of monomer with the initiator and each type of CLOISITE® were placed into a series of ten small test tubes. After degassing with nitrogen, these were sealed and placed into a pre-heated bath at 80° C. Each test tube was removed from the bath at pre-specified time intervals and was immediately frozen after the addition of a few drops of hydroquinone in order to stop the reaction. The product was then isolated after dissolving in CH₂Cl₂ and re-precipitating (recrystallizing) in methanol. A different procedure for the nanocomposite isolation was followed in the last two or three samples of each experiment. Since the reaction was already finished, and the polymer/nanofiller mixture was a solid, the test tubes were broken and the products were obtained as such. In this way, it was ensured that the filler was enclosed into the polymer matrix. Subsequently, all isolated materials were dried to constant weight in a vacuum oven at room temperature. All final samples were weighed and the degree of conversion was estimated gravimetrically.

In order to examine the resultant products, X-ray diffraction (XRD), Fourier-transform infrared (FTIR), differential scanning calorimetry (DSC), gel permeation chromatography (GPC), and thermogravimetric analysis (TGA) were all used. X-ray diffraction patterns were obtained using an X-ray diffractometer equipped with a CuKa generator (λ=0.1540 nm). Scans were taken in the range of diffraction angle 2θ=1-10°.

The chemical structure of the copolymer-based nanocomposites and the two different types of CLOISITE® were confirmed by recording their infrared (IR) spectra. The FTIR resolution used was 4 cm⁻¹. The recorded wavenumber range was from 4000 to 400 cm⁻¹, and 32 scans were averaged to reduce noise. Thin films were used in each measurement, formed by a hydraulic press.

In order to estimate the glass transition temperature of each nanocomposite prepared, DSC was used. About 10 mg of each sample was weighed, put into a standard sample pan, sealed, and placed in the appropriate position of the calorimeter. Subsequently, the samples were heated to 180° C. at a rate of 10° C. per minute to ensure complete polymerization of the residual monomer. Following this, the samples were cooled to 0° C., and their glass transition temperature was measured by heating again to 180° C. at a rate of 20° C. per minute.

The molecular weight distribution (MWD) and the average molecular weights of the pure copolymers and all nanocomposites were determined by GPC. The gel permeation chromatograph included an isocratic pump, a differential refractive index detector, and three PLgel 5μ MIXED-C columns in series. All samples were dissolved in tetrahydrofuran (THF) at a constant concentration of 1 mg per mL. After filtration, 200 μL of each sample was injected into the chromatograph. The elution solvent was THF at a constant flow rate of 1 mL per minute, and the entire system was kept at a constant temperature of 30° C.

The thermal stability of the samples was measured by thermogravimetric analysis. Samples of about 5 to 8 mg were used. The samples were heated from ambient temperature to 600° C. at a heating rate of 10° C. per minute under nitrogen flow, while the samples of clay were heated up to 800° C. Table 1 below shows the chemical structure of the organic modifiers of the different types of CLOISITE® used, together with their cation exchange capacity (CEC) and the d₀₀₁ spacing measured from XRD.

TABLE 1
Chemical Structure of the Organic Modifiers of Cloisite Samples

| | | CEC | | | d₀₀₁ (Ä) |
|---|---|---|---|---|---|
| | | (meq/100 | 2θ | d₀₀₁ (Ä) | (from |
| Sample | Organic modifier | g clay) | (°) | measured | supplier) |
| Cloisite ® | None | 92 | 7.46 | 11.8 | 11.7 |
| Na⁺ | | | | | |
| Cloisite ® 10A | 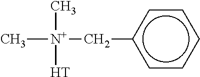 | 125 | 4.77 | 18.5 | 19.2 |
| Cloisite ® 15A | 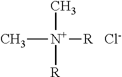 | 125 | 2.96 | 29.8 | 31.5 |

where R and HT are hydrogenated tallow (~65% C18, ~30% C16, ~5% C14).

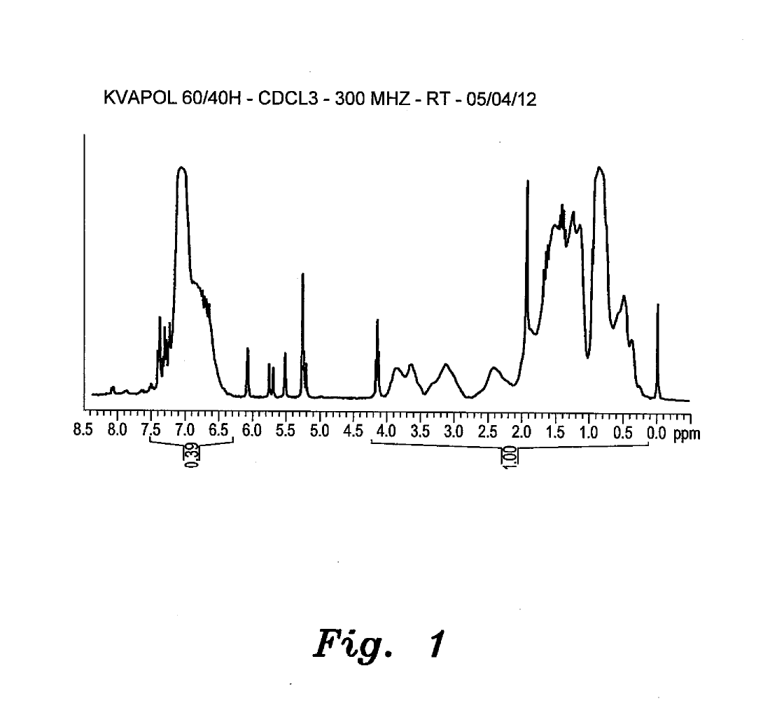

Initially, the ratio of each monomer bound in the copolymer was measured using ¹H nuclear magnetic resonance (NMR). A representative spectrum is shown in FIG. 1. The copolymer shows chemical shifts from the phenyl protons in the region of 6.6-7.3 ppm and from the methylene-oxy (—OCH₂—) protons of the BMA units in the region 2.7-4.1 ppm. The remainder of the spectrum contains signals for protons in the copolymer methane, methylene and methyl groups. Copolymer composition was estimated from proton NMR by taking the peak area from the phenyl protons as 5St, while the remainder of the spectrum is integrated to yield the remaining (3St+14BMA) protons. This ratio is used to calculate the molar percentage of styrene units in the copolymer. According to the peaks identified, it was estimated that the composition of the copolymer mixture in styrene to BMA (S:BMA) was 19:81 and 57:43 for the copolymers P(S-BMA) 20:80 and P(S-BMA) 60:40, respectively. Both values were close to the initial co-monomer mixture; i.e., composition drift is not taking place to a significant extent.

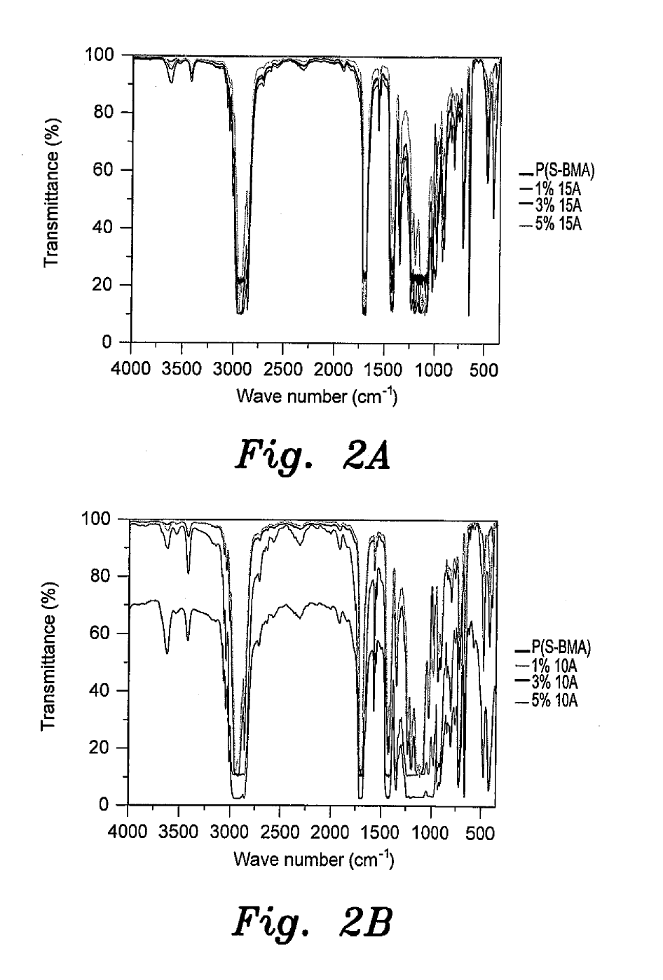

Further, in order to check if secondary chemical reactions occur between the monomers or free radicals and the organomodified clay, the FTIR spectra of the pure copolymer and of the nano-hybrids were recorded. The resultant curves are shown in FIGS. 2A and 2B for CLOISITE° 15A and CLOISITE® 10A, respectively. In both types of CLOISITE®, and at all relative amounts, no significant difference in the peaks was observed. Thus, it may be concluded that the OMMT is physically dispersed in the monomer mixture without forming any chemical bonding.

The type of nanocomposite formed was checked with XRD. Polymer-clay nanocomposites may be characterized as immiscible (tactoids), intercalated, partially exfoliated, or exfoliated. The particular form depends on the clay content, the chemical nature of the organic modifier, and the synthetic method. In general, an exfoliated system is more feasible with lower clay content (about 1 wt %), while an intercalated structure is frequently observed for nanocomposites with higher clay contents.

From XRD measurements, the d-spacing for CLOISITE® Na⁺, CLOISITE® 15A and CLOISITE® 10A were measured as 1.18, 2.98 and 1.85 nm, respectively. The d-spacing for CLOISITE® 15A and CLOISITE® 10A were both larger than that of CLOISITE® Na⁺, indicating that the intercalant certainly intercalates into the silicate layer of MMT.

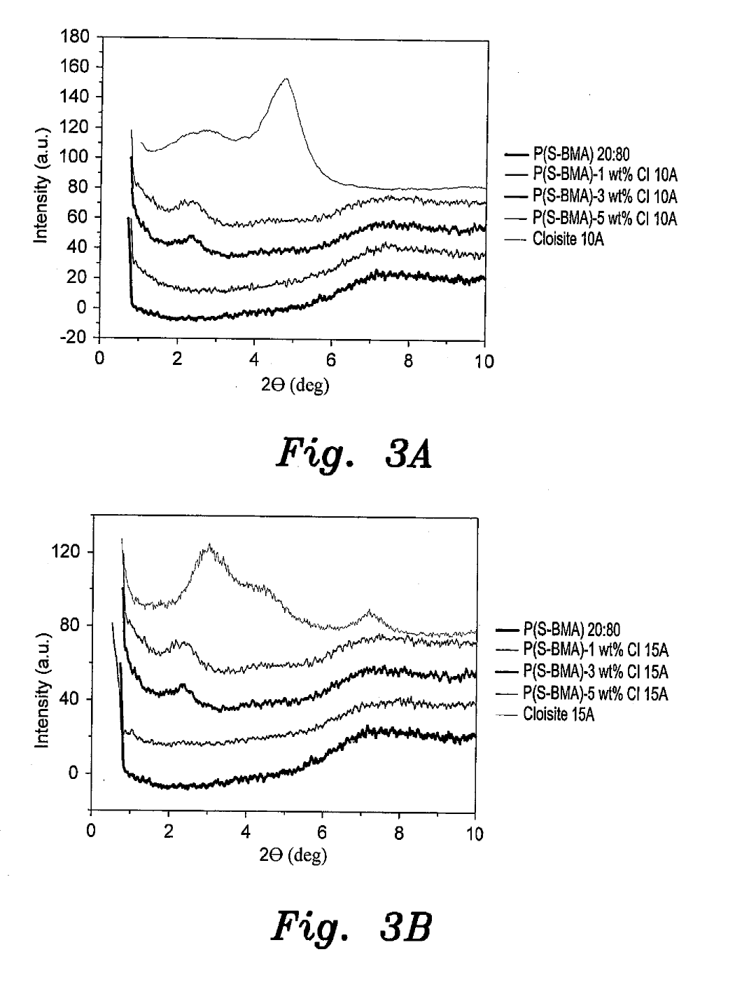

The XRD diffractograms of pure P(S-BMA) 20:80 and the nanocomposites with 1.0, 3.0 and 5.0 wt % CLOISITE® 15A, or 1.0, 3.0 and 5.0 wt % CLOISITE° 10A, are shown in FIGS. 3A and 3B, respectively. No significant peaks were observed for pure P(S-BMA) or the nanocomposites with 1.0 wt % of either CLOISITE® WA or 15A. The non-existence of peaks in the XRD diffractograms suggests that the polymer/clay nanocomposites have an exfoliated morphology. As the amount of the OMMT increases to 3.0 or 5.0 wt %, the strong (001) plane peak corresponding to d₀₀₁ was clearly observed with increased peak intensity. The d₀₀₁-spacings of the nanocomposites were 3.8 and 3.7 nm for compositions of 3.0 and 5.0 wt %, respectively. No significant trend of the change in d-spacing was observed as a function of loading. The indexing of the d₀₀₁ peak in the diffractograms suggests that the morphology of the polymer/clay nanocomposites is intercalated. Thus, it may be concluded from the XRD patterns that the nanocomposites with 1.0 wt % nano-filler are rather exfoliated, while those with higher than 1.0 wt % OMMT could be considered as partially exfoliated and intercalated.

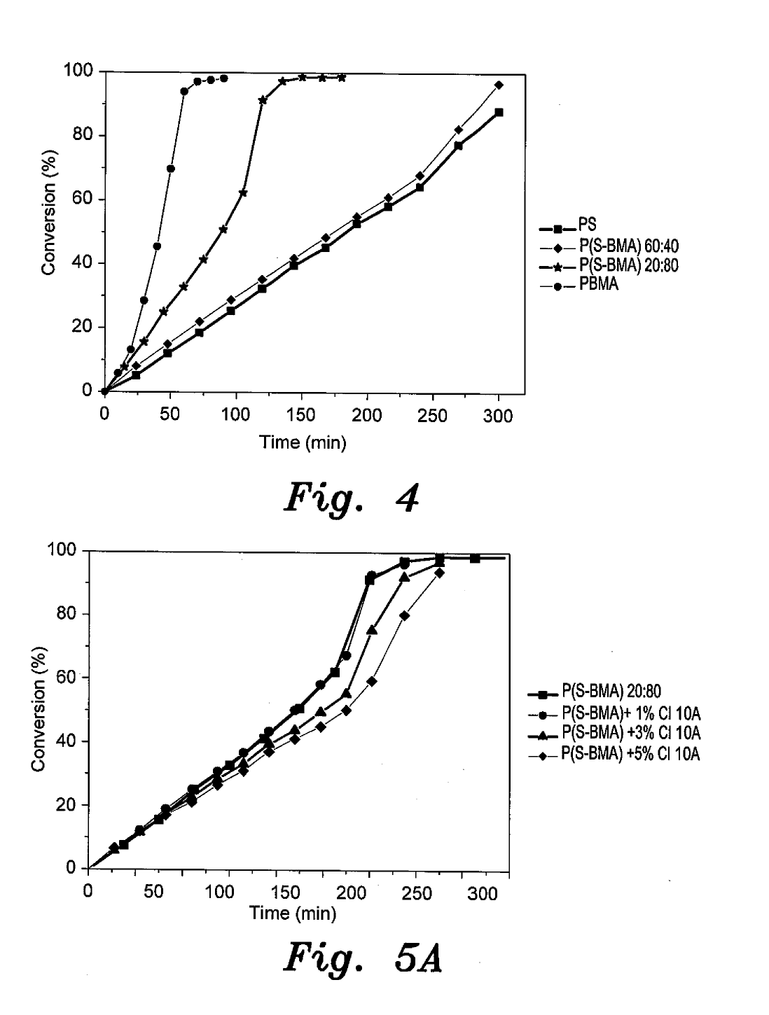

The evolution of conversion with time measured for the two homo-polymers polystyrene and poly(butyl methacrylate), as well as the two copolymers studied here, P(S-BMA) 60:40 and P(S-BMA) 20:80, are shown in FIG. 4. It can be seen that copolymer P(S-BMA) 60:40 has a curve similar to that of polystyrene (PS), while the other copolymer has characteristics in between the two homo-polymers. In particular, PS presents kinetics that are mainly kinetically controlled, with a slight effect of diffusion-controlled phenomena only at high degrees of conversion. PBMA has a curve typical of poly(alkyl methacrylates), having a strong gel-effect starting at low conversions (i.e., near 20%). The reaction curve of the P(S-BMA) 20:80 copolymer presents classical kinetics until almost 50% conversion, while the increase in the conversion time curve afterwards is characteristic of auto-acceleration due to the effect of diffusion-controlled phenomena on the termination reaction. The effect of diffusion-controlled phenomena also on the propagation reaction results in final conversion values less than 100%.

The presence of nano-particles may influence polymerization kinetics, especially in monomers exhibiting strong effects of diffusion phenomena on the reaction kinetics. These results are attributed to the decreased free-volume of the reacting mixture, as well as to the restriction imposed in the diffusion of macro-radicals in space due to the existence of the organic modifiers in the MMT platelets, which constitute relatively large molecules. Therefore, the OMMT platelets with the large chemical structures of the modifiers add an extra hindrance in the movement of the macro-radicals in space in order to find one another and react (i.e., terminate), resulting in locally increased radical concentrations. Thus, the presence of OMMT nanoparticles seems to enhance the polymerization rate and slightly shorten the polymerization time to achieve a specific monomer conversion.

Further, using a high amount of OMMT (i.e., 5.0 wt %), it can be seen that the ultimate conversion was near 91-92 wt %, which is lower than that of pure poly(methyl methacrylate) (PMMA) (i.e., 96-97 wt %). This is attributed to the hindered movement of the small monomer molecules to find a macro-radical and react due to the high amount of nano-filler at high monomer conversions. Therefore, larger amounts of monomer molecules remain unreacted.

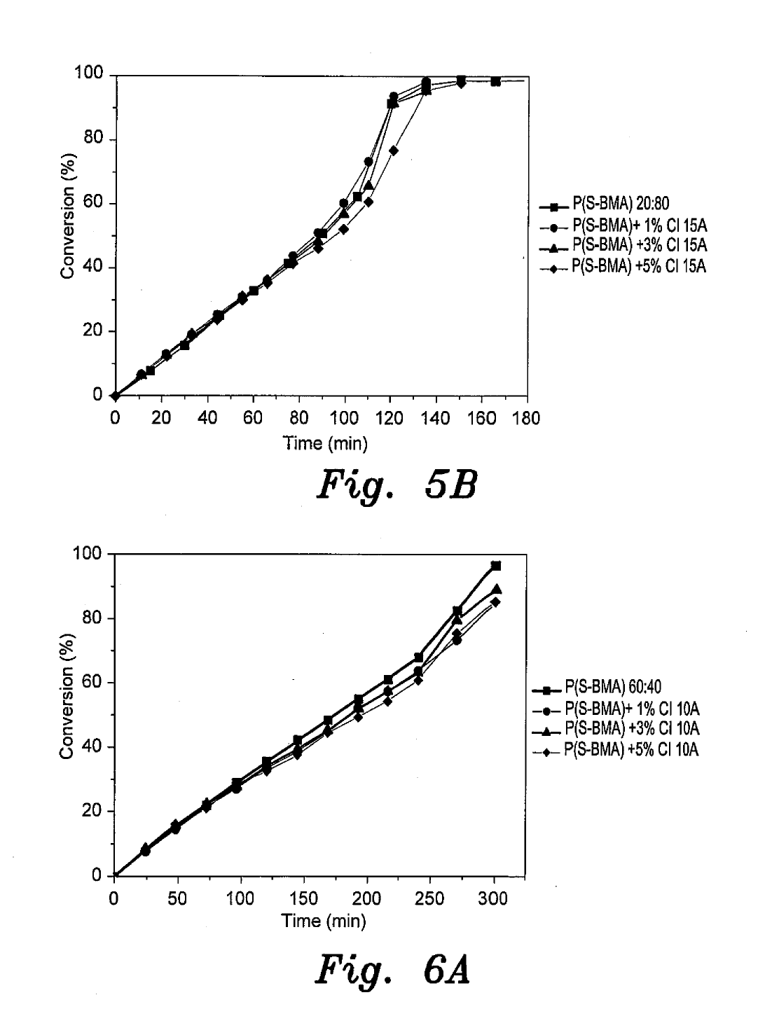

In FIGS. 5A and 5B, conversion versus time curves are shown for P(S-BMA) 20:80 based nanocomposites with different amounts of CLOISITE® 10A and CLOISITE® 15A, respectively. Very good reproducibility was observed in all conversion ranges (within ±1%). From an examination of the curves, typical behavior as in pure PBMA was observed in almost all experiments. In the first stage of polymerization (i.e., low conversions), the conversion vs. time curve, as well as the polymerization rate (Rp) versus time t, follows the classical free-radical kinetics. An almost linear dependence of conversion (X) appears, denoting purely chemical control of the polymerization. After a certain point in the vicinity of 50% conversion, an increase in the reaction rate takes place, followed by an increase in the conversion values. This is the well-known auto-acceleration or gel effect, and is attributed to the effect of diffusion-controlled phenomena on the termination reaction and the reduced mobility of live macro-radicals in order to find one another and react. Therefore, their concentration increases locally, leading to increased reaction rates. Afterwards, the reaction rate falls significantly, and the curvature of the conversion versus time changes.

At this conversion interval, from about 50 to 90%, the observed decrease in the termination reaction rate is not so abrupt, but is rather gradual. At this stage, the center-of-mass motion of radical chains becomes very slow, and any movement of the growing radical site is attributed to the addition of monomer molecules at the chain end. This additional diffusion mechanism is “reaction diffusion”. The higher the propagation reaction rate value, the more likely is reaction-diffusion to be rate-determining. Finally, at very high conversions (beyond 90%), the reaction rate tends asymptotically to zero, and the reaction almost stops before the full consumption of the monomer. This situation corresponds to the well-known glass effect. This is attributed to the effect of diffusion-controlled phenomena on the propagation reaction and the reduced mobility of monomer molecules to find a macro-radical and react.

As can be seen in FIGS. 5A and 5B, in both cases, the addition of 1.0 wt % nano-filler does not affect the conversion vs. time curves. However, an increase in the amount of the nano-filler from 3.0 to 5.0 wt % appears to slightly retard the reaction, leading to decreased conversion values, particularly at high degrees of conversion. This is more pronounced when CLOISITe 10A is used. This may be attributed to the hindered movement of the small monomer molecules to find a macro-radical and react due to the high amount of nano-filler and polymer chains at high monomer conversions. Therefore, larger amounts of monomer molecules remain unreacted. An additional factor may be the MMT acting as a radical scavenger. It should be noted that the ultimate conversion values were higher (i.e., 97-99%) compared to PMMA-based nanocomposites, since the glass transition temperature of the copolymer is below that of PMMA (i.e., near 100° C.). Thus, CLOISITE® 15A appears to be the best nano-filler for this copolymer.

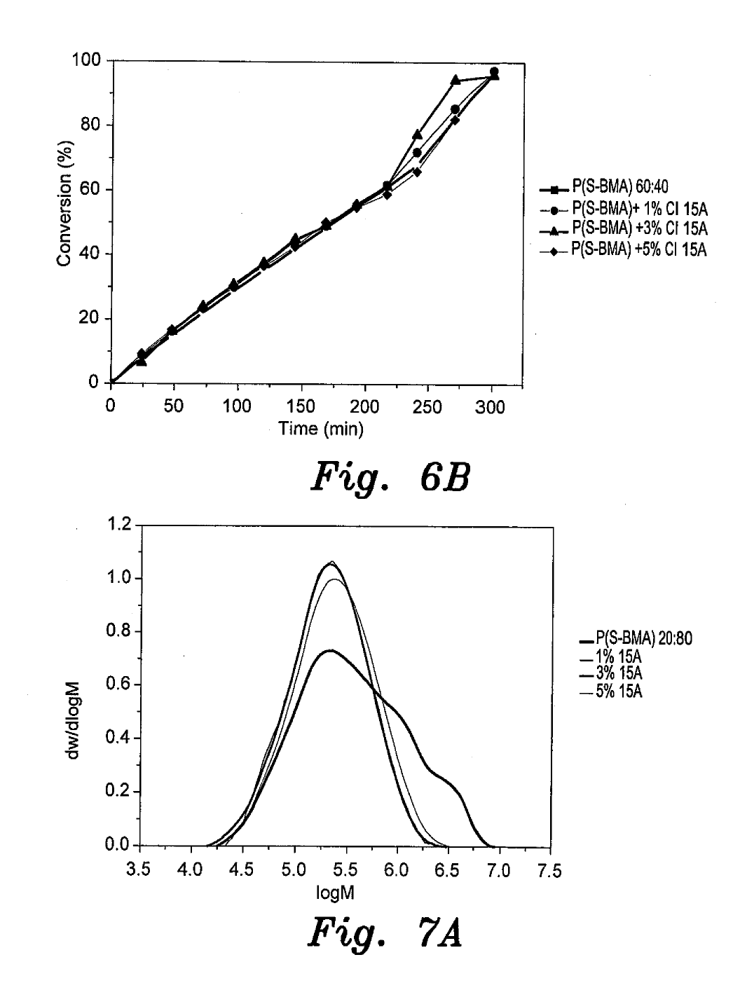

The polymerization kinetics in the presence of a nano-filler in the case of a copolymer not exhibiting strong auto-acceleration effects (i.e., P(S-BMA) 60:40) were also investigated. As was seen in FIG. 4, this copolymer presents a slower reaction rate compared to the other copolymer, along with strong diffusion-controlled phenomena during the reaction being nearly absent. As shown in FIGS. 6A and 6B, the presence of different types and amounts of CLOISITE® 10A and CLOISITE® 15A (1.0, 3.0 and 5.0 wt %), respectively, does not appear to greatly influence the reaction rate within experimental error. Thus, it may be postulated that the presence of the OMMT does not influence polymerization kinetics to any great degree in the case where diffusion-controlled phenomena do not influence the reaction rate.

The glass transition temperature of the final samples of pure P(S-BMA) 20:80, P(S-BMA) 60:40 and all of their nanocomposites were measured using DSC. All of the resultant Tg values are shown below in Table 2. The value measured for pure P(S-BMA) 20:80 (30° C.) is close to that of pure PBMA, i.e., 29° C. Further, the value measured for P(S-BMA) 60:40 (i.e., 45° C.) is higher following the increased amount of styrene in the macromolecular chain. It was also found that the polymer/clay nanocomposites presented slightly lower Tg than that of the pure polymers. This may be due to the increased restricted segmental chain mobility of the copolymer anchored to the silicate surface.

TABLE 2
Characteristics as Affected by Nanocomposite Composition

| | | | | Tg |
|---|---|---|---|---|
| Sample | M̅_{N} | M̅_{W} | PD | (° C.) |
| P(S-BMA) 20:80 | 188760 | 734390 | 3.89 | 30 |
| P(S-BMA) + 1% CLOISITE ® 10A | 170650 | 647020 | 3.79 | 28 |
| P(S-BMA) + 3% CLOISITE ® 10A | 169420 | 445160 | 2.63 | 26 |
| P(S-BMA) + 5% CLOISITE ® 10A | 161180 | 587010 | 3.64 | 23 |
| P(S-BMA) + 1% CLOISITE ® 15A | 148980 | 296260 | 1.99 | 29 |
| P(S-BMA) + 3% CLOISITE ® 15A | 142840 | 295690 | 2.07 | 27 |
| P(S-BMA) + 5% CLOISITE ® 15A | 160900 | 346770 | 2.15 | 28 |
| P(S-BMA) 60:40 | 78380 | 145690 | 1.86 | 45 |
| P(S-BMA) + 1% CLOISITE ® 10A | 84840 | 180140 | 2.12 | 39 |
| P(S-BMA) + 3% CLOISITE ® 10A | 85980 | 164890 | 1.92 | 40 |
| P(S-BMA) + 5% CLOISITE ® 10A | 101330 | 317720 | 3.13 | 28 |
| P(S-BMA) + 1% CLOISITE ® 15A | 84150 | 157820 | 1.87 | 42 |
| P(S-BMA) + 3% CLOISITE ® 15A | 75420 | 158390 | 2.10 | 35 |
| P(S-BMA) + 5% CLOISITE ® 15A | 77360 | 179460 | 2.32 | 32 |

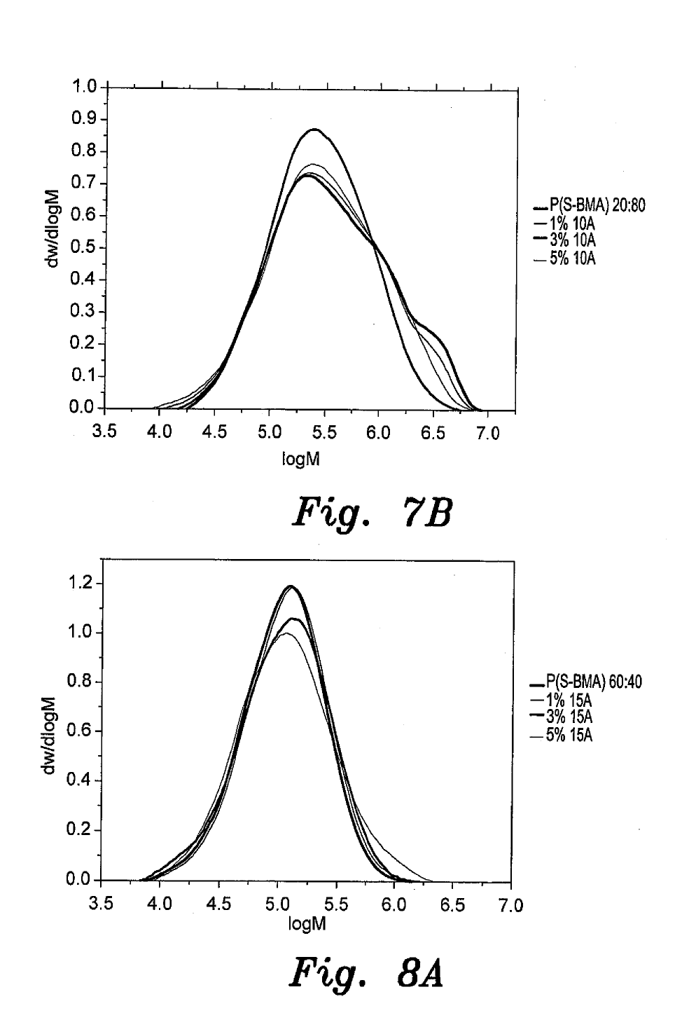

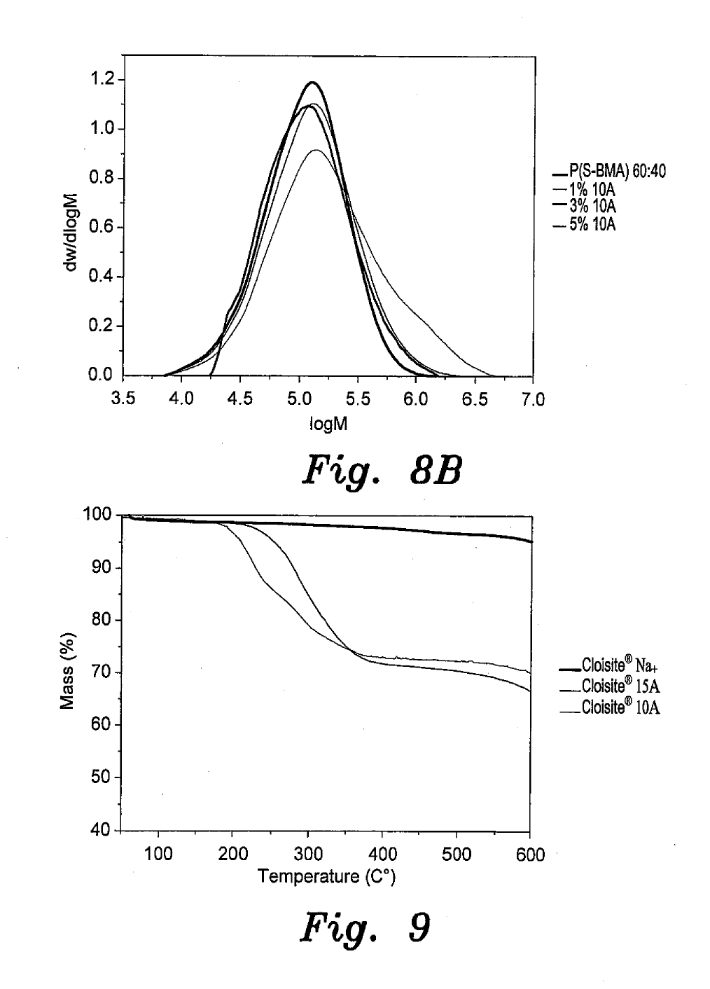

The full molecular weight determination (MWD) of all samples was measured, and the results are shown in FIGS. 7A and 8A for the CLOISITE® 15A samples, and in FIGS. 7B and 8B for the CLOISITE® 10A samples. Further, the average molecular number, average molecular weight ( M̅_{N} and M̅_{W}), and polydispersity index of the pure copolymers and all nanocomposites, are shown above in Table 2. As can be seen, all of the materials based on P(S-BMA) 60:40 (i.e., with higher amounts of styrene) had a GPC elution pattern characteristic of a monomodal distribution. This was also verified from the rather low polydispersity indices measured (in the vicinity of 2). In contrast, P(S-BMA) 20:80 and its nanocomposites with CLOISITE® 10A presented a bimodal distribution having PD indices greater than 3. Additionally, all average molecular values of the copolymer and the nanocomposites based on the latter copolymer were higher when compared to those based on P(S-BMA) 60:40. This is attributed to the lower amount of styrene in the copolymer chains, which results in longer macromolecular chains. Further, the MWD of the P(S-BMA) 20:80 nanocomposites was shifted to lower molecular weights when compared to the pure copolymer. The shifting of the MWD of the P(S-BMA) 60:40 nanocomposites to either higher or lower values was not as clear as in the previous case.

The thermal degradation of the CLOISITE® samples was investigated, and the corresponding TGA curves appear in FIG. 9. It can be seen that CLOISITE® Na⁺ (CLOISITE® without the organic modifier) is very slightly degraded (less than 3%), even at 500° C. All of the organomodified CLOISITE® samples present some thermal degradation, starting at about 220° C., up to almost 380° C. The mass loss is almost 28% and 26% for the CLOISITE® 15A and CLOISITE® 10A, respectively. However, since the amount of OMMT used in the formation of the nanocomposites was very low (i.e., 1.0 wt % in most experiments, and up to 5.0 wt %), the degradation of the nanofiller itself is not expected to affect the values of the nanocomposites' mass losses by more than 0.28%, or 1.4% at the maximum.

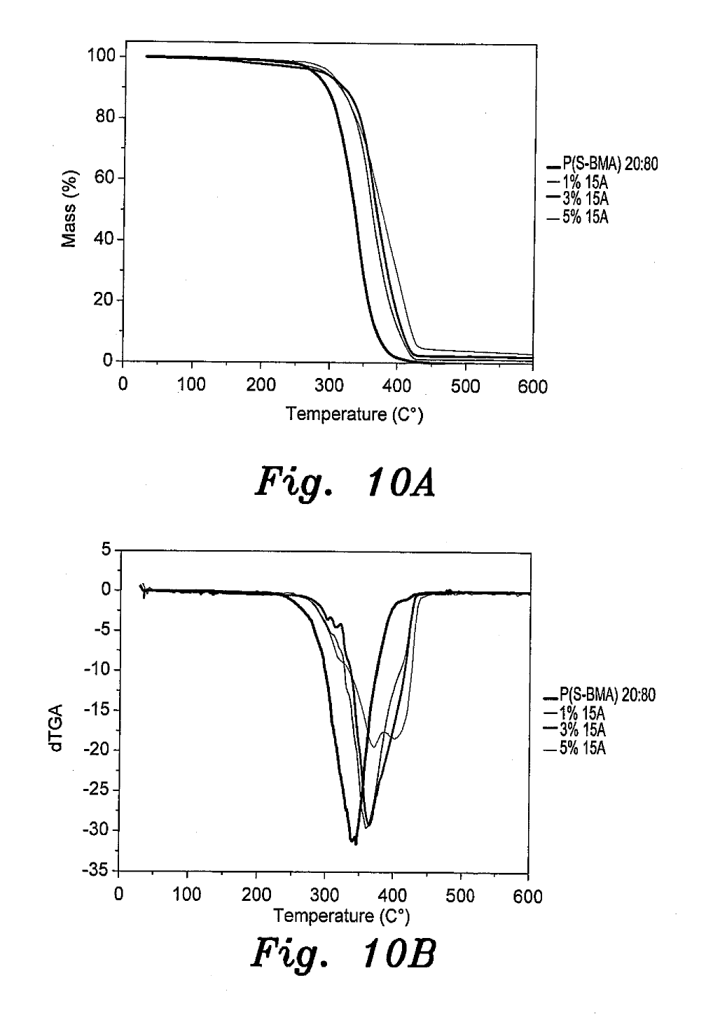

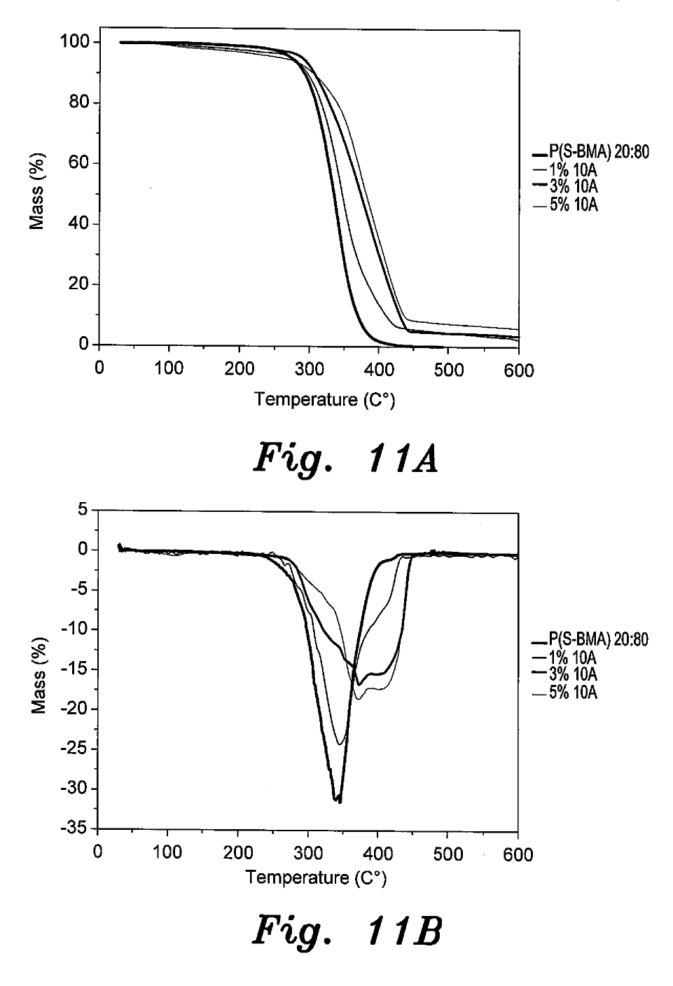

FIGS. 10A and 10B show mass loss and DTGA curves for the CLOISITE® 15A samples, respectively. FIGS. 11A and 11B show mass loss and DTGA curves for the CLOISITE® 10A samples, respectively. Each of these Figures compares pure P(S-BMA) 20:80 against the P(S-BMA) 20:80 based nanocomposites. From these Figures, it can be seen that the thermal stability of the P(S-BMA)/MMT nanocomposites improved when compared to the pure copolymer, as expressed by a shifting of the degradation curve to higher temperatures. The origin of this increase in the decomposition temperatures may be attributed to the ability of nanometer silicate layers to obstruct volatile gas produced by thermal decomposition. Thus, thermal decomposition begins from the surface of the nanocomposites, leading in an increase of the organo-MMT content and the formation of a protection layer by the clay. Alternatively, nanoconfinement may also be used to describe this phenomenon. Based upon a nanoconfinement view, polymer degradation starts and the newly formed radicals are nanoconfined, permitting a variety of bimolecular reactions to occur. As degradation progresses, the clay platelets, driven by a decrease in the surface free energy, migrate gradually to the surface and form the barrier.

In terms of the OMMT type, the best thermal stability, as evidenced by an increase in T_{10%} (i.e., temperature at 10% degradation) of almost 10° C., was achieved in the nanocomposites formed when CLOISITE® 10A was used. The residual mass of all other nanocomposites is in accordance with the amount of OMMT initially loaded. Further, from the DTGA curves, a double peak was observed in all nanocomposites, compared to one peak in the pure copolymer. This is an indication that the degradation mechanism is taking place in two separate steps, compared to a single step in the pure copolymer. Thus, the presence of the nano-filler shifts the second peak to higher degradation temperatures, which implies a protection effect with regard to degradation of the material. Moreover, as the amount of the CLOISITE® 15A increases, the first peak at lower temperatures decreases, while the second peak increases, providing a higher resistance to thermal degradation (as shown in FIGS. 10A and 10B).

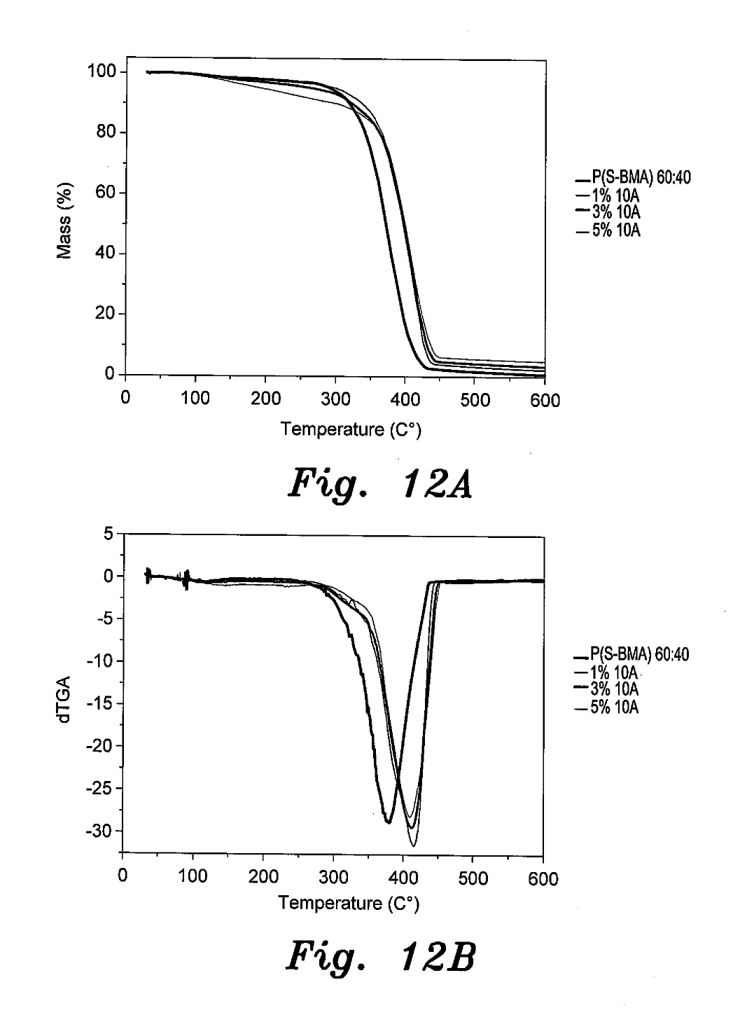

FIG. 12A illustrates the mass loss of P(S-BMA) 60:40/CLOISITE® 10A. FIG. 12B illustrates the DTGA of P(S-BMA) 60:40/CLOISITE® 10A, both due to thermal degradation. From both FIG. 12A and FIG. 12B, it can be seen that the thermal stability of the P(S-BMA)/MMT nanocomposites improved when compared to the pure copolymer, as expressed by a shifting of the degradation curve to higher temperatures. It can be further seen that degradation completes mainly in one step, both for the pure copolymer and all nanocomposites. Thermal stability did not significantly change when the amount of CLOISITE® 10A was increased. From the TGA measurements, it may also be seen that better thermal stability was attained for the P(S-BMA) 60:40 copolymers when compared to P(S-BMA) 20:80. The higher amount of styrene in the copolymer results in better thermal stability of the copolymer.

It is to be understood that the present invention is not limited to the embodiments described above, but encompasses any and all embodiments within the scope of the following claims.

We claim:

1. A method of making a polymer-clay nanocomposite material by in situ polymerization, comprising the steps of:
dispersing nanoparticles of an organo-montmorillonite clay in a mixture of styrene and butyl methacrylate monomers in a styrene to butyl methacrylate ratio of about 20 to 80, the organo-montmorillonite clay being between 1.0 wt % and 5.0 wt % of the combined mixture;
adding a free radical initiator to the mixture; and
heating the mixture to about 80° C.

2. The method of making a polymer-clay nanocomposite material as recited in claim 1, wherein the organo-montmorillonite clay comprises montmorillonite modified with a quaternary ammonium salt.

3. The method of making a polymer-clay nanocomposite material as recited in claim 1, wherein the step of dispersing the organo-montmorillonite clay in the styrene and butyl methacrylate mixture comprises magnetic and ultrasonic agitation.

4. The method of making a polymer-clay nanocomposite material as recited in claim 1, wherein the free radical initiator comprises benzoyl peroxide.

5. The method of making a polymer-clay nanocomposite material as recited in claim 1, wherein the organo-montmorillonite clay comprises montmorillonite modified with a dimethyl, benzyl, hydrogenated tallow quaternary ammonium salt.

6. The method of making a polymer-clay nanocomposite material as recited in claim 1, wherein the organo-montmorillonite clay comprises montmorillonite modified with a dimethyl, dihydrogenated tallow quaternary ammonium salt.

7. A polymer-clay nanocomposite material made by the process of claim 1.

8. A method of making a polymer-clay nanocomposite material by in situ polymerization, comprising the steps of:
dispersing nanoparticles of an organo-montmorillonite clay in a mixture of styrene and butyl methacrylate monomers in a styrene to butyl methacrylate ratio of about 60 to 40, the organo-montmorillonite clay being between 1.0 wt % and 5.0 wt % of the combined mixture;
adding a free radical initiator to the mixture; and
heating the mixture to about 80° C.

9. The method of making a polymer-clay nanocomposite material as recited in claim 8, wherein the organo-montmorillonite clay comprises montmorillonite modified with a quaternary ammonium salt.

10. The method of making a polymer-clay nanocomposite material as recited in claim 8, wherein the step of dispersing the organo-montmorillonite clay in the styrene and butyl methacrylate mixture comprises magnetic and ultrasonic agitation.

11. The method of making a polymer-clay nanocomposite material as recited in claim 8, wherein the step of adding a free radical initiator to the mixture comprises adding benzoyl peroxide to the mixture.

12. The method of making a polymer-clay nanocomposite material as recited in claim 8, wherein the organo-montmorillonite clay comprises montmorillonite modified with a dimethyl, benzyl, hydrogenated tallow quaternary ammonium salt.

13. The method of making a polymer-clay nanocomposite material as recited in claim 12, wherein the organo-montmorillonite clay comprises montmorillonite modified with a dimethyl, dihydrogenated tallow quaternary ammonium salt.

14. A polymer-clay nanocomposite material made by the process of claim 8.

15. A method of making a polymer-clay nanocomposite material, comprising the steps of:
dispersing nanoparticles of an organo-montmorillonite clay in a mixture of polystyrene and butyl methacrylate monomers, the organo-montmorillonite clay being between 1.0 wt % and 5.0 wt % of the combined mixture;
adding a free radical initiator to the mixture; and
heating the mixture to about 80° C. to copolymerize the monomers.

16. The method of making a polymer-clay nanocomposite material as recited in claim 15, wherein the organo-montmorillonite clay comprises montmorillonite modified with a dimethyl, benzyl, hydrogenated tallow quaternary ammonium salt.

17. The method of making a polymer-clay nanocomposite material as recited in claim 15, wherein the organo-montmorillonite clay comprises montmorillonite modified with a dimethyl, dihydrogenated tallow quaternary ammonium salt.

18. The method of making a polymer-clay nanocomposite material as recited in claim 15, wherein the mixture of polystyrene and butyl methacrylate monomers comprises a styrene to butyl methacrylate ratio of about 20 to 80.

19. The method of making a polymer-clay nanocomposite material as recited in claim 15, wherein the mixture of polystyrene and butyl methacrylate monomers comprises a styrene to butyl methacrylate ratio of about 60 to 40.

20. The method of making a polymer-clay nanocomposite material as recited in claim 19, wherein the step of adding a free radical initiator to the mixture comprises adding benzoyl peroxide to the mixture.
